(19) United States
(12) Patent Application Publication
(10) Pub. No.: US 2024/0391018 A1
(43) Pub. Date: Nov. 28, 2024

(54) TWO-PIECE TOOL FOR FRICTION STIR WELDING TOOL ASSEMBLY

(71) Applicant: EVERWELL ADVANCED TECHNOLOGY CO., LTD, Taoyuan City (TW)

(72) Inventors: Chih-Wei HUANG, Taoyuan City (TW); Huan-Chieh YEN, Taoyuan City (TW); Chien-Hsun HUANG, Taoyuan City (TW)

(21) Appl. No.: 18/590,042

(22) Filed: Feb. 28, 2024

(30) Foreign Application Priority Data
May 26, 2023 (TW) 112119614

(51) Int. Cl. B23K 20/12

(52) U.S. Cl. CPC B23K 20/1255; B23K 20/123

(57) ABSTRACT

A two-piece tool includes a female tool member, a stirring tool member and a bolt. The female tool member has a friction-generating shoulder for generating friction with two workpieces, an axial through hole and a radial threaded hole. The axial through hole is extended through a center of the friction-generating shoulder along a central axis of the female tool member. The radial threaded hole is extended in a radial direction of the female tool member and is in communication with the axial through hole. The stirring tool member has a fixed section and a stirring section. The fixed section is inserted in the axial through hole. The stirring section is extended from the friction-generating shoulder in a direction pointing away from the axial through hole. The bolt is threaded in the radial threaded hole to abut against the fixed section.

### BACKGROUND OF THE INVENTION

### 1. Technical Field

The present invention relates to a tool for friction stir welding.

### 2. Description of Related Art

Friction stir welding is carried out by driving the pin of a friction stir welding tool into a butt joint between two workpieces and then moving the tool along the butt joint while rotating the tool. During the process, friction is generated by the rotation of the tool, and the mechanical kinetic energy of the tool is converted into thermal energy such that the portions of the two workpieces that are subjected to friction are plastically deformed by the heat. As the tool continues moving and rotating, the materials of the plastically deformed portions of the two workpieces are stirred and the workpieces are joined together as a result.

Most of the pins used in the conventional friction stir welding technology are designed in one piece.

### BRIEF SUMMARY OF THE INVENTION

The primary objective of the present invention is to provide a friction stir welding tool pin with freedom in material selection.

To achieve the foregoing and other objectives, the present invention provides a two-piece tool for friction stir welding tool assembly. The two-piece tool includes a female tool member, a stirring tool member and a bolt. The female tool member has a friction-generating shoulder for generating friction with two workpieces, an axial through hole and a radial threaded hole. The axial through hole is extended through a center of the friction-generating shoulder along a central axis of the female tool member. The radial threaded hole is extended in a radial direction of the female tool member and is in communication with the axial through hole. The stirring tool member has a fixed section and a stirring section. The fixed section is inserted in the axial through hole. The stirring section is extended from the friction-generating shoulder in a direction pointing away from the axial through hole. The stirring section is adapted to be driven into a gap between the two workpieces for stirring. The bolt is threaded in the radial threaded hole to abut against the fixed section.

The other features and effects of the present invention are stated further below.

### BRIEF DESCRIPTION OF THE SEVERAL VIEWS OF THE DRAWINGS

FIG. 1 is a perspective view of the two-piece tool in an embodiment of the present invention.

FIG. 2 is an exploded view of the two-piece tool in FIG. 1.

FIG. 3 is a sectional view of the two-piece tool in FIG. 1.

### DETAILED DESCRIPTION OF THE INVENTION

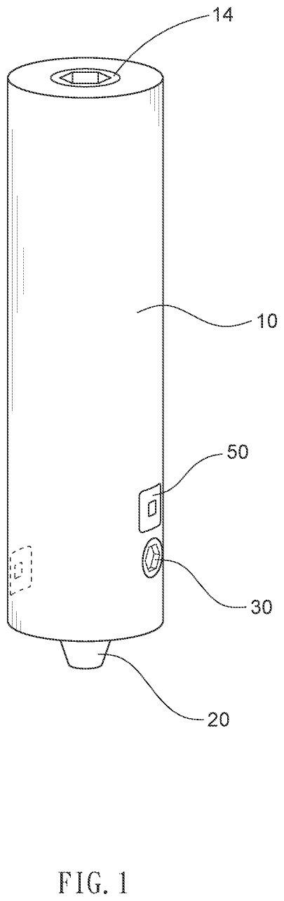

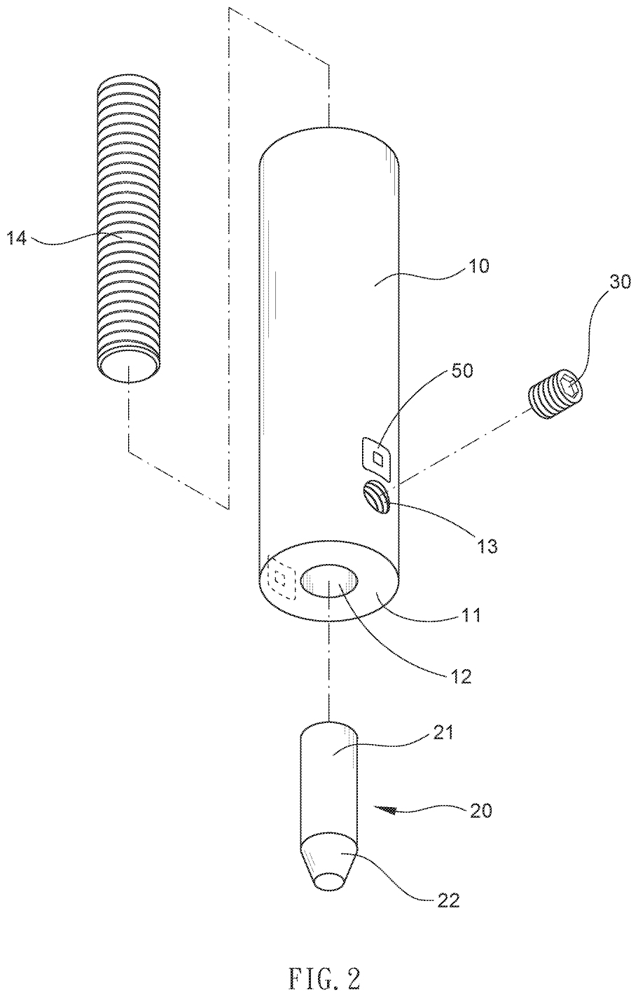

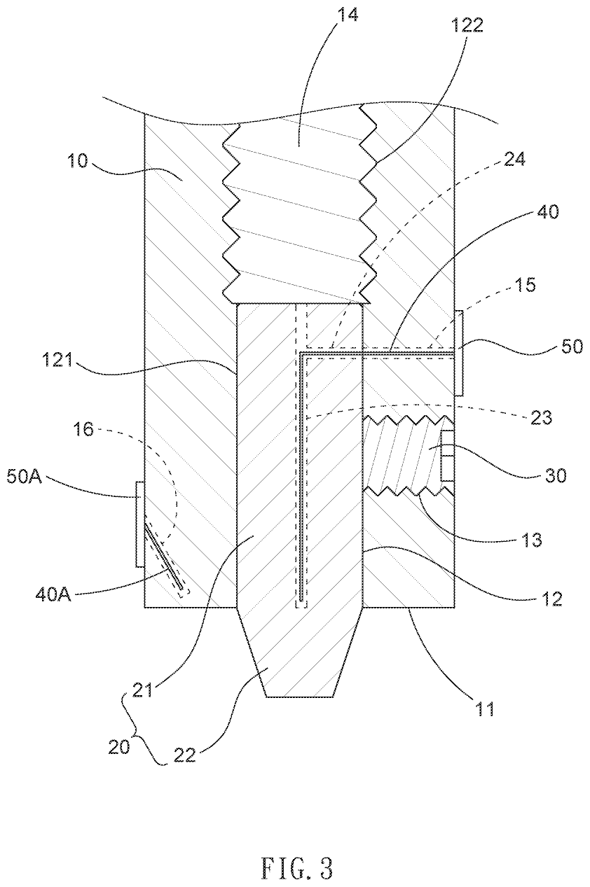

Referring to FIG. 1 to FIG. 3, the two-piece tool according to an embodiment of the present invention can be installed on a friction stir welding tool assembly, which can be mounted on the processing shaft of a machine tool in order to perform a friction stir welding process on two workpieces.

The two-piece tool includes a female tool member 10, a stirring tool member 20, a bolt 30, a temperature-sensing probe 40, and a wireless transmitter 50.

The female tool member 10 has a friction-generating shoulder 11 for generating friction with the two workpieces, an axial through hole 12, a radial threaded hole 13, and a set screw 14. The axial through hole 12 extends through the center of the friction-generating shoulder 11 along the central axis of the female tool member 10. The axial through hole 12 has a smooth-wall section 121 adjacent to the friction-generating shoulder 11 and a threaded section 122 located away from the friction-generating shoulder 11. The set screw 14 is threadedly provided in the threaded section 122. The radial threaded hole 13 extends in a radial direction of the female tool member 10 and is in communication with the axial through hole 12.

The stirring tool member 20 has a fixed section 21 and a stirring section 22. The fixed section 21 is inserted in the smooth-wall section 121 of the axial through hole 12 such that one end of the fixed section 21 abuts against the set screw 14. The depth to which the fixed section 21 is inserted into the axial through hole 12 can be fine-tuned with the set screw 14. The stirring section 22 extends from the friction-generating shoulder 11 in a direction pointing away from the axial through hole 12. The stirring section 22 is configured to be driven into the gap between the two workpieces W to stir the plasticized workpiece material and thereby weld the two workpieces W together. Depending on the material properties (e.g., the melting point) of the workpieces W, among other considerations, the female tool member 10 and the stirring tool member 20 may be made of, for example, but not limited to, ceramic, polycrystalline cubic boron nitride, a tungsten-rhenium alloy, carbon steel, high tensile steel, a titanium alloy, titanium or a copper alloy. One of the major functions of the female tool member 10 in a friction stir welding process is to generate friction and the resulting heat and one of the major functions of the stirring tool member 20 in a friction stir welding process is to stir the plasticized workpiece material. In other words, the female tool member 10 and the stirring tool member 20 do not have exactly the same functions. In a feasible embodiment, therefore, the material of the female tool member 10 may be different from that of the stirring tool member 20 in order to meet both functional and cost-reduction requirements.

The bolt 30 is threadedly provided in the radial threaded hole 13, abuts against the fixed section 21 and thereby fixes the stirring tool member 20 to the female tool member 10.

The temperature-sensing probe 40 is configured to contact and sense the working temperature of the stirring tool member 20. The stirring tool member 20 has an axial probe-receiving hole 23 and a radial probe-receiving hole 24 and the female tool member 10 has a probe-receiving hole 15. The radial probe-receiving hole 24 is connected between and in communication with, the axial probe-receiving hole 23 and the probe-receiving hole 15. The temperature-sensing probe 40 is configured to be inserted in the axial probe-receiving hole 23, the radial probe-receiving hole 24, and the probe-receiving hole 15 to monitor if the working temperature of the stirring tool member 20 falls in a preset working temperature range.

The wireless transmitter 50 is electrically connected to the temperature-sensing probe 40 and is configured to transmit the temperature sensed by the temperature-sensing probe 40 to an external controller or computation system. The wireless transmitter 50 may be provided, for example, on a lateral side of the female tool member 10 but is not necessarily so located.

In this embodiment, there is another temperature-sensing probe 40A and another wireless transmitter 50A, and the female tool member 10 further has a near-shoulder probe-receiving hole 16. The near-shoulder probe-receiving hole 16 extends from the outer peripheral wall of the female tool member 10 to a position adjacent to the friction-generating shoulder 11. The temperature-sensing probe 40A is inserted in the near-shoulder probe-receiving hole 16 and is electrically connected to the wireless transmitter 50A to detect the working temperature of the friction-generating shoulder 11.

What is claimed is:

1. A two-piece tool for friction stir welding tool assembly comprising:
a female tool member, having a friction-generating shoulder for generating friction with two workpieces, an axial through hole and a radial threaded hole, the axial through hole being extended through a center of the friction-generating shoulder along a central axis of the female tool member, the radial threaded hole being extended in a radial direction of the female tool member and being in communication with the axial through hole;
a stirring tool member, having a fixed section and a stirring section, the fixed section being inserted in the axial through hole, the stirring section being extended from the friction-generating shoulder in a direction pointing away from the axial through hole, the stirring section being adapted to be driven into a gap between the two workpieces for stirring; and
a bolt, being threaded in the radial threaded hole to abut against the fixed section.

2. The two-piece tool of claim 1, further comprising a temperature-sensing probe and a wireless transmitter electrically connected to the temperature-sensing probe, the temperature-sensing probe being adapted to contact and sense a working temperature of the stirring tool member.

3. The two-piece tool of claim 2, wherein the wireless transmitter is disposed on the female tool member.

4. The two-piece tool of claim 1, wherein the female tool member and the stirring tool member are made of different materials.

5. The two-piece tool of claim 1, wherein the axial through hole has a smooth-wall section adjacent to the friction-generating shoulder and a threaded section located away from the friction-generating shoulder, the female tool member further has a set screw threaded in the threaded section, the set screw is adapted to abut against an end of the fixed section to adjust a depth to which the fixed section is inserted into the axial through hole.

6. The two-piece tool of claim 2, wherein the stirring tool member has an axial probe-receiving hole and a radial probe-receiving hole, the female tool member has a probe-receiving hole, the radial probe-receiving hole is connected between and in communication with the axial probe-receiving hole and the probe-receiving hole, the temperature-sensing is inserted in the axial probe-receiving hole, the radial probe receiving hole and the probe-receiving hole.
